(19) United States
(12) Patent Application Publication
(10) Pub. No.: US 2009/0016151 A1
(43) Pub. Date: Jan. 15, 2009

(54) Particulate collector for mixing container

(76) Inventor: Joel S. Beaton, Horseheads, NY (US)

Correspondence Address: DAVID GIGLIO, ESQ., 231 ELIZABETH STREET, UTICA, NY, 13501, US

(21) Appl. No.: 11/827,071

(22) Filed: Jul. 11, 2007

(51) Int. Cl. B01F 15/00; B01F 13/06

(52) U.S. Cl. 366/139; 210/248

(57) ABSTRACT

The present invention provides a particulate collection apparatus for use in mixing powdery substances such as mortar and grout into a paste like workable compound. The particulate collection apparatus includes an upper member which engages a top surface of a mixing container. The upper member includes a plurality of equidistant spaced openings, preferably along its top surface which extend into a hollowed chamber. The hollowed chamber further includes an exteriorly situate opening which mates with a vacuum hose. As such the vacuum creates a draws billowing particulars through the hollowed chamber and into a vacuum storage chamber.

### FIELD OF THE INVENTION

The present invention relates generally to the field of masonry and, more particularly, to the field of mixing mortar and grout in a mixing container.

### BACKGROUND OF THE INVENTION

In the tile setting and masonry trades it is always necessary to mix mortar and grouts for installation and replacement of tiles, bricks and the like. Mortar and grout are typically made by mixing powdery compound with a sufficient amount of water to create a paste like substance. The paste like substance is then applied with a trowel or other tool either to secure the tile or brick or to fill in a gap between the same.

The mixing typically takes place in a portable container, such as a five gallon bucket. The user first pours the powdery compound into the bucket and then adds water and stirs the mixture.

Several problems arise during the mixing process. First when pouring the powder into the container, powder particulate billows out and creates a mess. Worse yet the powder is physically harmful when breathed in. For installers, who work with the mortar and grout on a routine basis it is often necessary to wear a particulate mask when mixing the compound.

Even after the particulate settles, more particulate is created when mixing the compound as the powder is turned over and over to join with the water.

### SUMMARY AND OBJECTS OF THE INVENTION

It is an object of the present invention to improve the field of tile setting and masonry.

It is another object of the present invention to make it safer for workers who mix masonry compounds.

It is a further object of the present invention to keep work sites cleaner when mixing masonry compounds.

It is a feature of the present invention to provide a mixing container which makes it safer for workers working with masonry compounds.

It is another feature of the present invention to provide a mixing container which assists a mason in keeping his work site clean.

It is yet another feature of the present invention to provide a mixing container which cooperates with a vacuum system to prevent masonry particulate from billowing from the mixing container during the mixing process.

These and other objects and features are provided in accordance with the present invention in which a particulate collection apparatus prevents the billowing spillover from a mortar and grout mixing container. The apparatus includes an upper member which engages a top surface of a mixing container.

A downwardly disposed inner engagement member disposed from said upper member engages a top portion of an interior surface of said container. A downwardly disposed outer engagement member disposed from the upper member engages a top portion of an exterior surface of the container, thereby keeping the particulate collection apparatus in place with respect to the mixing container.

The upper member includes a plurality of openings, preferably in a top surface. The plurality of spaced opening extend to a hollowed channel. The hollowed channel further includes an opening that is used to mate with a vacuum hose. A vacuum creates a down draft which draws the billowing particulates through the vacuum.

### BRIEF DESCRIPTION OF THE DRAWINGS

The present invention will be understood and appreciated more fully from the following detailed description taken in conjunction with the drawings in which:

FIG. 1 is a perspective view of a particulate collection apparatus in conjunction with a mixing container and vacuum device in accordance with a preferred embodiment of the present invention;

FIG. 2 is a cross sectional side elevation view of the particulate collection apparatus of FIG. 1;

FIG. 3 is a cross sectional side elevation view of the particulate collection apparatus of FIG. 3 in use with a mixing container;

FIG. 4 is a top view of the particulate collection apparatus of FIG. 1 depicting a plurality of spaced opening in a top surface of an upper member; and

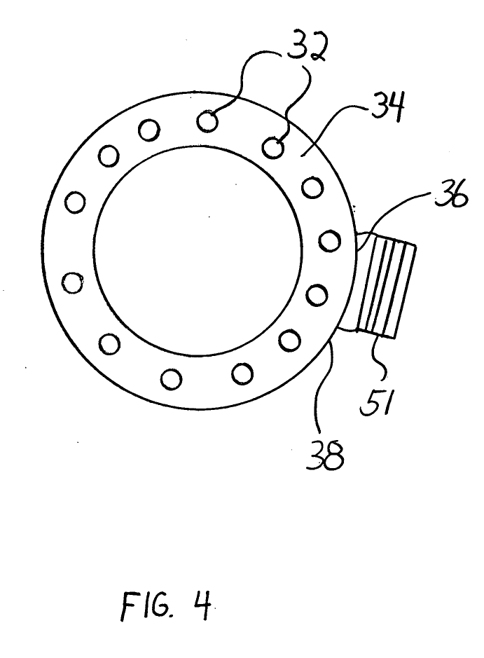

FIG. 5 is a side elevational view of an alternative embodiment of a particulate collection apparatus.

### DETAILED DESCRIPTION OF THE PRESENT INVENTION

The present invention will now be described in accordance with a preferred embodiment. As will become apparent to one skilled in the art many modifications, different shapes and sizes and different materials all lie within the spirit and scope of the present invention.

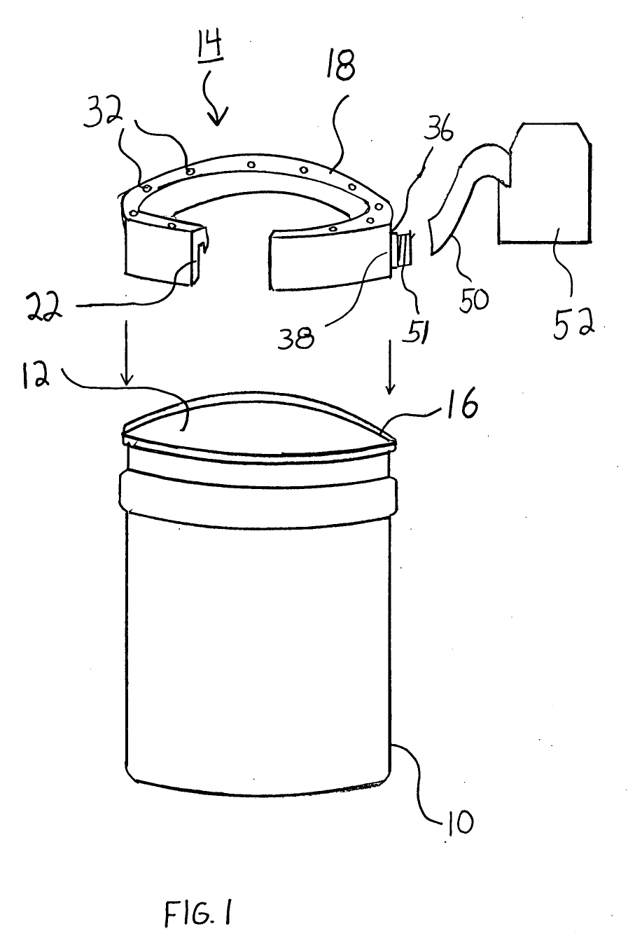

Turning now to FIG. 1, there is depicted a five gallon mixing container 10 which is often used to mix various masonry compounds such as mortar and grout. The five gallon mixing container 10 includes an interior surface 12 in which mixing is accomplished.

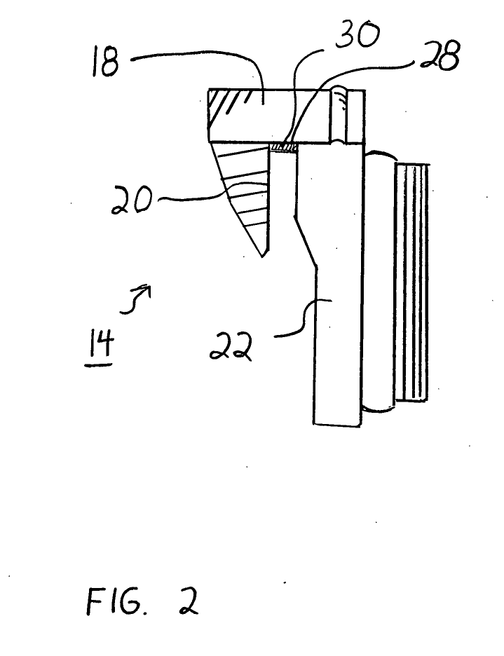

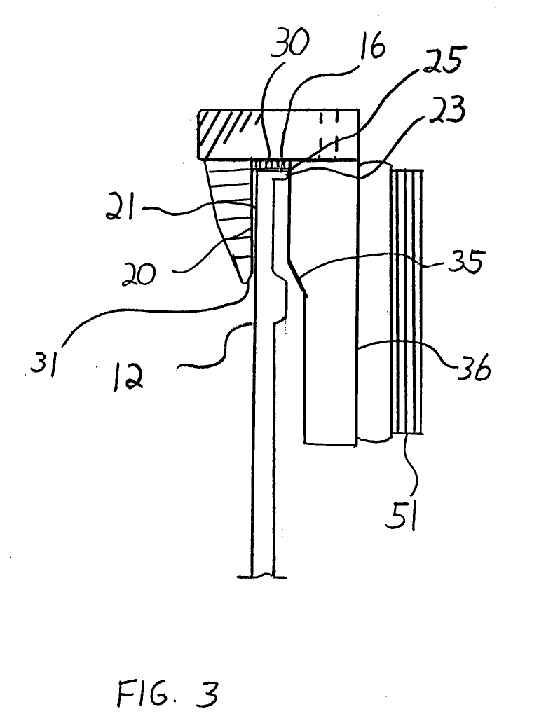

An annular particulate collecting ring 14, depicted in FIGS. 2 and 3, cooperates with a top annular surface 16 of the five gallon mixing container 10. In order to mate with the top annular surface 16, the annular particulate collecting ring 14 includes a top annular member 18, an inner annular flange 20 which extends downwardly the top annular member 18, and an outer annular channel 22 which also extends downward from the top annular member 18.

A beveled edge 31 on the inner annular flange 20 and a beveled edge 35 on the inner annular surface 23 of the outer annular channel 22 guides the top annular surface 16 of the mixing container 10 upward toward the sealing o-ring 30.

An underside 28 of the top annular member 18 includes a rubberized o-ring 30 which lies on top of the top annular surface 16 of the five gallon mixing container 10. The rubberized o-ring 30 prevents particulates from passing from the interior of the five gallon mixing container 10 and under the outer annular channel 22.

As installed in FIG. 3, the o-ring 30 sets directly on the top annular surface 16 forming a friction joint. The inner annular flange 20 preferable fits against a top portion 21 of the interior surface 12 of the five gallon mixing container. The outer annular channel 22 includes an inner annular surface 23 which preferable fits against an outer surface portion 25 of the five gallon mixing container 10.

The annular particulate collecting ring 14 includes a number of evenly spaced openings 32 in a top surface 34. The openings 32 extend to the outer annular channel 22 which is preferable hollowed.

The outer annular channel 22 further includes an opening 36 in an outer surface 38 which terminates at a connector 51, which is sized to accommodate a standardized shop vacuum hose 50.

In operation, the user pours the powdery mixing compound (not shown) into the five gallon mixing container 10. As typically will happen, the dust billows out over the top annular surface 16 of the five gallon mixing container 10.

However, when the shop vacuum is activated, a downdraft is created through the openings 32. The particulates that were billowing over the five gallon mixing container 10 are now sucked through the openings 32 due to the downdraft. As the particulates accumulate in the outer annular channel 22 they are sucked through the vacuum hose 50 and safely into a vacuum chamber 52.

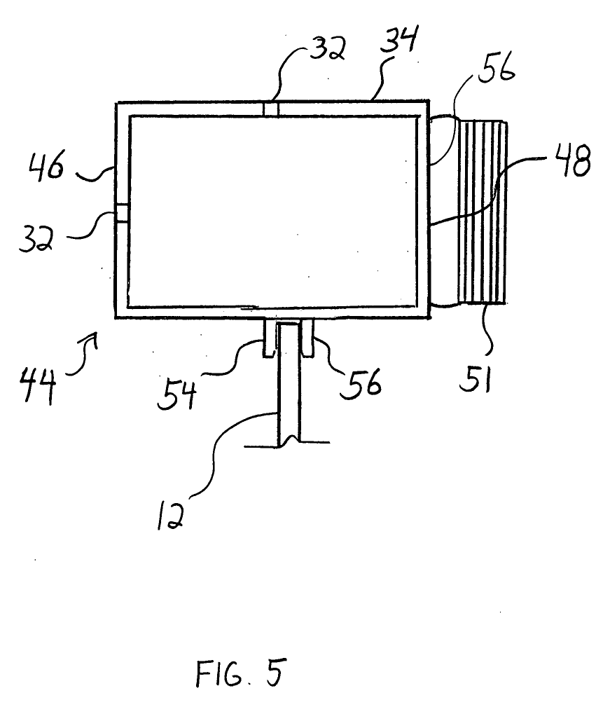

Turning now to FIG. 5, an annular particulate collecting ring 44 includes a pair of connecting clips 54, 56 which secures the collecting ring 44 to the container 12. The openings 32 are placed either/or both at the top surface 34 or at an interior surface 46. In this matter, the opening 56 and connector 51 are disposed at an outer surface 48 of the annular particulate collecting ring 44.

In a preferred embodiment, the annular particulate collecting ring 14 is made of a high density polyethylene material and includes a minimum thickness of 90 mil. For the embodiment described herein, the annular particulate collecting ring 14 measures 13¼″ in diameter, the top annular member 18 measures 1½″ wide, and the outer annular chamber 22 measures 4¼″ from top to bottom.

It is readily understood that mixing containers come in various shapes and sizes. For example, a mixing container may be rectangular shaped. In that situation, the particulate collecting ring must be shaped to accommodate the top surface of the mixing container, or in that example must be rectangular shaped.

The present invention may also be applied in various other fields such is in baking. Bakers often must mix powdery substances to form a paste like compound before baking. The mixing process therein also causes particulates to billow from the mixing container. Therefore, the present invention is suitable in other fields.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What I claim is:

1. A particulate collection apparatus for use prevention of billowing spillover from a mortar and grout mixing container, said apparatus comprising:
a upper member which engages a top surface of said mixing container;
a downwardly disposed inner engagement member disposed from said upper member, wherein said inner engagement member engages a top portion of an interior surface of said container;
a downward disposed outer engagement member disposed from said upper member, wherein said outer engagement member engages a top portion of an exterior surface of said container;
at least one opening in said upper member;
a hollowed channel cooperating with said at least one opening; and
at least one exterior opening disposed in said hollowed channel for mating with a vacuum means.

2. The particulate collection apparatus of claim 1, wherein said at least one opening is disposed in a top surface of said upper member.

3. The particulate collection apparatus of claim 1, wherein said at least one opening is disposed in an inner surface of said upper member.

4. The particulate collection apparatus of claim 1, wherein said hollowed channel is formed in said upper member in conjunction with a downwardly disposed outer member.

5. The particulate collection apparatus of claim 1, wherein said hollowed channel is formed in said upper member, and said at least one exterior opening is disposed at an outer surface of said upper member.

6. The particulate collection apparatus of claim 1, wherein said upper member further includes an underside having a sealing member disposed thereon.

7. A mixing apparatus for mixing a powdery substance with a fluid to achieve a paste-like compound, said apparatus comprising:
a housing having an interior and exterior surface and a top surface;
a particulate collection member which includes,
an upper member which engages a top surface of said mixing container,
a downwardly disposed inner engagement member disposed from said upper member, wherein said inner engagement member engages a top portion of an interior surface of said container,
a downward disposed outer engagement member disposed from said upper member, wherein said outer engagement member engages a top portion of an exterior surface of said container,
at least one opening in said upper member,
a hollowed channel cooperating with said at least one opening, and
at least one exterior opening disposed in said hollowed channel for mating with a vacuum means; and
a vacuum means which includes a mating member that mates with said at least one opening of said hollowed channel, said vacuum means further including a storage chamber.

8. The mixing container of claim 7, wherein said at least one opening further includes a plurality of equidistant spaced openings.

9. The mixing container of claim 7, wherein said housing top surface is circular.

10. The mixing container of claim 7, wherein said housing top surface is rectangular.

11. The mixing container of claim 7, wherein the upper member of said particulate collection member further includes an underside having a sealing member disposed thereto.

12. The particulate collection apparatus of claim 7, wherein said at least one opening is disposed in a top surface of said upper member.

13. The particulate collection apparatus of claim 7, wherein said at least one opening is disposed in an inner surface of said upper member.

14. The particulate collection apparatus of claim 7, wherein said hollowed channel is formed in said upper member in conjunction with a downwardly disposed outer member.

15. The particulate collection apparatus of claim 7, wherein said hollowed channel is formed in said upper member, and said at least one exterior opening is disposed at an outer surface of said upper member.
